(19) United States
(12) Patent Application Publication
(10) Pub. No.: US 2009/0313905 A1
(43) Pub. Date: Dec. 24, 2009

(54) METHOD AND APPARATUS FOR ASSEMBLY OF CMP POLISHING PADS

(76) Inventors: Stephen Fisher, San Jose, CA (US); Lynn Fisher, San Jose, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/141,907

(22) Filed: Jun. 18, 2008

(51) Int. Cl. B24D 11/00; B23P 19/00

(52) U.S. Cl. 51/295; 29/700

(57) ABSTRACT

Polishing pads made up of individual polishing elements that protrude through holes in a guide plate are assembled by cascading a number of such polishing elements through a stack of assembly boxes in each of which are located the guide plates such that the polishing elements pass from an uppermost assembly box in the stack to a lowermost assembly box in the stack and in each respective assembly box of the stack are distributed over a respective guide plate therein. Accordingly, at least some of the polishing elements are captured within holes of the respective guide plates in the respective assembly boxes. The cascading may be initiated by displacement of the stack of assembly boxes about a pivot and the distribution of the polishing elements within the assembly boxes may be initiated by lateral displacement of the assembly boxes in the stack.

### FIELD OF THE INVENTION

The present invention relates generally to the field of automated assembly, and in particular to an apparatus and method for assembling discrete polishing elements into a guide plate to fashion a polishing pad used for the chemical mechanical planarization of integrated circuits.

### BACKGROUND

In modern integrated circuit (IC) fabrication, layers of material are applied to embedded structures previously formed on semiconductor wafers. Chemical mechanical planarization (CMP) is an abrasive process used to remove excess material from these layers and polish the resulting surface to achieve a desired structure and material profile. CMP may be performed on both oxides and metals and generally involves the use of chemical slurries applied in conjunction with a polishing pad that is put in motion relative to the wafer (e.g., rotational motion relative to the wafer). The resulting smooth flat surface is necessary to maintain proper photolithographic depth of focus for subsequent wafer processing steps and to ensure that metal interconnects are not deformed over underlying features on the wafer. Damascene processing requires metal, such as tungsten or copper, to be removed from a top surface of a dielectric to define interconnect structures, using CMP.

There is described in U.S. patent application Ser. No. 11/697,622, filed 6 Apr. 2007, which application is assigned to the assignee of the present invention and incorporated herein by reference, a CMP polishing pad having individual polishing elements. FIG. 1 is a cut-away side profile view of such a polishing pad 100. In use, polishing pad 100 rotates relative to the wafer surface being polished, the surface of the polishing pad making contact with the wafer (typically under pressure) at wafer contact surface 102. A slurry distribution material 104 provides flow control in the slurry pathways between individual polishing elements 106. The foundation of polishing pad 100 is the guide plate 108, which provides lateral support for the polishing elements 106.

In particular, guide plate 108 includes holes to accommodate each of the polishing elements 106, which may be fixed to an underlying compressible foam layer 112 by an adhesive such as double sided tape or epoxy. Nevertheless, each polishing element 106 remains free to move (i.e., compress) in a direction along its long axis through the holes in guide plate 108, which supports the polishing elements. The polishing elements are thus each maintained in planar orientation with respect to one other and the guide plate. A typical guide plate can be as large as 30 inches in diameter and may support up to 5000 polishing elements.

As shown, the interdigitated polishing elements 106 protrude above surface of the guide plate 108, thus providing a volume between the polishing elements 106 and the guide plate 108 for slurry distribution. In various embodiments, the polishing elements 106 may also protrude above the slurry distribution material 104. The slurry distribution material 104 may include flow resistant elements such as baffles or grooves (not shown), or pores, to regulate slurry flow rate during CMP processing and may be fastened to the guide plate 208 by an adhesive, such as double sided tape.

The polishing pad may also include an optional membrane 110 (e.g., an ion exchange membrane that allows charge to pass but not liquid), located on the surface of the guide plate 108 and forming a barrier between the guide plate 108 and the slurry distribution material 104 and between each portion of the polishing elements 106 extending into the guide plate 108. In other cases, the membrane may be located below the guide plate 108. Membrane 110 may be a conductive or non-conductive membrane and fastened to the guide plate 108 by an adhesive, such as two-sided tape or epoxy.

Conventional methods of assembling a polishing pad such as pad 100 are expensive and labor intensive; particularly when it comes to the assembly of the polishing elements with the guide plate. The labor intensive nature of the assembly process has several consequences. First, the labor increases the final cost of the assembled pad. Second, the assemblers are limited in both the precision and speed with which the polishing elements can be assembled to the guide plate. Third, while precision robotic assembly is an option, the cost would be prohibitive due to the high number of parts. Also, robotic assembly requires a high degree of repeatability in part dimensions for uninterrupted assembly. Again, to minimize costs, incoming part dimensions may exceed the specifications for robotic assembly.

### SUMMARY OF THE INVENTION

In one embodiment, an apparatus for assembling a polishing pad includes one or more assembly boxes, each configured to support a guide plate therein, the guide plate having through holes for accepting polishing elements, and further having an exit port sufficient to permit polishing elements to pass therethrough; means for oscillating the assembly boxes arranged as a stack; and means for tilting the assembly boxes arranged as a stack. A recovery unit adapted to be positioned below the assembly boxes when arranged as a stack and to collect polishing elements into a collection area when the polishing elements pass through a respective exit port of a lowermost one of the assembly boxes arranged as a stack may also be included. So too may a vertical conveyor assembly adapted to collect polishing elements from the collection area and to transport the polishing elements to a topmost one of the assembly boxes arranged as a stack be included.

The means for oscillating may be a motor coupled to a table on which the assembly boxes arranged as a stack are positioned. The means for titling may be a tilt table on which rests the table and which is configured to be tilted about a pivot by means of a level screw.

A further embodiment of the invention provides an apparatus for assembling a polishing pad that includes one or more assembly boxes, each configured to support a guide plate therein, the guide plate having through holes for accepting polishing elements, and further having an exit port sufficient to permit polishing elements to pass therethrough; and means for displacing the assembly boxes arranged as a stack so that the polishing elements are distributed over respective guide plates in respective ones of the assembly boxes and to cascade from an uppermost one of the assembly boxes to a lower most one of the assembly boxes in the stack by means of the exit port in each respective one of the assembly boxes. The apparatus may also include a collection area for the polishing elements positioned so as to collect the polishing elements when the polishing elements exit the lowermost one of the assembly boxes in the stack. This collection area may be an area of a recovery unit configured to displace the polishing elements from a location where the polishing elements ext the lowermost one of the assembly boxes in the stack to the collection area.

In some cases, a sensor adapted to indicate a level of polishing elements within the collection area may be included. Further, means for delivering the polishing elements from the collection area to the uppermost one of the assembly boxes in the stack may be provided.

Another embodiment of the invention involves cascading a number of polishing elements through a stack of assembly boxes in each of which are located guide plates having holes there through such that the polishing elements pass from an uppermost assembly box in the stack to a lowermost assembly box in the stack and in each respective assembly box of the stack are distributed over a respective guide plate therein, whereby at least some of the polishing elements are captured within holes of the respective guide plates in the respective assembly boxes. The cascading may be initiated by displacement of the stack of assembly boxes about a pivot (for which an appropriate tile table may be provided). The distribution of the polishing elements within the assembly boxes may be initiated by lateral displacement of the assembly boxes in the stack. The assembly boxes may be oscillated using a motor coupled to a table on which the stack of assembly boxes is located.

These and further embodiments of the invention are discussed in detail below.

### BRIEF DESCRIPTION OF THE DRAWINGS

The present invention is illustrated by way of example, and not limitation, in the figures of the accompanying drawings, in which:

FIG. 1 illustrates an example of a polishing pad having individual polishing elements in accordance with an embodiment of the present invention;

FIG. 2 illustrates a side view of an example of an assembly box for use with an assembly apparatus in accordance with an embodiment of the present invention;

FIG. 3 is a top view of the assembly box shown in FIG. 2;

FIG. 4 illustrates an example of a pad assembly apparatus configured in accordance with an embodiment of the present invention;

FIG. 5 is a flow chart illustrating a method of assembling a polishing pad in accordance with an embodiment of the present invention; and

FIG. 6 shows a side view of an assembled polishing pad.

### DETAILED DESCRIPTION

Described herein are methods and systems for the automated assembly of a polishing pad having individual polishing elements such as the pad described in the above-cited U.S. patent application Ser. No. 11/697,622 and shown in FIG. 1. Many of the above-described problems with the assembly of such a pad when performed by human assemblers can be reduced or eliminated by employing an apparatus configured for the automated assembly of such a pad using the methods described herein. The proposed automated assembly machine and methods should result in lower processing and capital costs, and have greater flexibility to accommodate variations in component types, geometries and tolerances. With respect to the problem of parts having dimensions that fall outside of specifications, such components are naturally sorted out as a result of the proposed cascading sequence.

As described in detail below, the proposed automated assembly device for assembling polishing pads having individual polishing elements (or at least portions thereof) makes use of a stack of assembly boxes. Each assembly box is configured for the assembly of an individual polishing pad, or at least that portion of the pad that includes the polishing elements and the guide plate. Typically, each assembly box is configured for the assembly of one polishing pad at a time, but in some cases, assembly boxes may be configured to accommodate the assembly of more than one polishing pad. One implementation of the automated assembly device uses a stack of three assembly boxes per assembly cycle, but this is not critical to the present invention. Assembly box stacks having any number of assembly boxes (i.e., one or more such boxes) may be used.

By stacking assembly boxes in the automated assembly device, the present invention provides for a cascading operation wherein individual polishing elements “flow” from an upper assembly box within the stack to lower assembly boxes within the stack until either the individual polishing element is “captured” by a polishing pad guide plate within a hole thereof, or the individual polishing element reaches the bottom of the stack of assembly boxes without having been so captured. In this latter case, the subject polishing element is returned (e.g., by way of a vertical conveyor arrangement) to the uppermost assembly box in the stack to begin the cascade process again. This continues until all or nearly all of the polishing elements have been consumed by being integrated within respective guide plates of the polishing pads being assembled, or all of the guide plates have received polishing elements within all of their respective holes. In some cases, for example, where the guide plates provide holes of different diameters adapted to receive polishing elements of different types, multiple assembly cycles with polishing elements of different kinds or types may be needed until each guide plate has received polishing elements into each hole.

Within an individual assembly box, a subject guide plate is held in planar orientation so that the holes in the guide plate are oriented vertically, ready to receive polishing elements. The guide plate may be held in place with clips at its edges. Stand off posts in the center and half radius of the plate may also be used to avoid having the guide plate resonate at certain frequencies, thereby dislodging previously captured polishing elements. A number of polishing elements are placed into the assembly box and are distributed over the surface of the guide plate by the rapid lateral oscillation of the assembly box. As this action is being performed, the polishing elements (which are free to move within the assembly box) will, when in the correct orientation with their long axes oriented approximately normal to the plane of the guide plate, be captured by holes in the guide plate. That is, the polishing elements will be “gravity fed” into the holes in the guide plate as they come into correct vertical alignment as the assembly box is being oscillated.

In order to ensure that the polishing elements do not fall through the holes in the guide plate, the base of each polishing element may be fashioned so that it is larger in diameter than the body of the polishing element. Such a polishing element is described in the above-cited U.S. patent application Ser. No. 11/697,622. In some cases, it may be necessary to fashion the individual polishing elements so that they are more heavily weighted towards the polishing tip thereof than towards the base, so as to encourage the polishing elements to adopt a “tip down” orientation as they are being distributed within an assembly box during the pad assembly process. The aspect ratio of the polishing elements is such that the element tends to come to rest on its side when agitated on a flat surface. When the element then encounters a hole in that surface, it will fall through and be captured at the flange.

If desired, once a guide plate has its complete complement of polishing elements distributed therein, a compressible foam underlayer or other backing may be affixed to the guide plate-polishing element assembly (e.g., by double sided tape, epoxy or other adhesive) so as to complete the polishing pad. This may be done by hand or by other automated process, for example by moving the entire assembly within the assembly box to an apparatus configured for the automated application of such a backing. The backing (and, optionally an intervening ion membrane) is applied so that it interfaces with the exposed base of the polishing elements and the uncovered portion of the guide plate. This leaves the tip portion of each of the polishing elements free to move in a direction normal to the plane of the guide plate without affecting the displacement of polishing elements adjacent thereto.

In some cases, the guide plate may have a slurry distribution layer affixed to a face of the guide plate opposite that which will be adhered to the backing. In such a case, the slurry distribution layer will require holes therethrough that correspond to the holes in the guide plate. In some cases it may be preferable to attach this slurry distribution layer after the polishing elements have been assembled into the guide plate and secured through the use of the backing. For example, this may be done by removing the guide plate-polishing element assembly from the assembly box and manually affixing the slurry distribution layer in place by aligning the holes therein with the protruding polishing elements. Alternatively, this may be done in an automated fashion. In some (perhaps most) cases, the slurry distribution foam will be laminated to the guide plate prior to placing the guide plate in the assembly system.

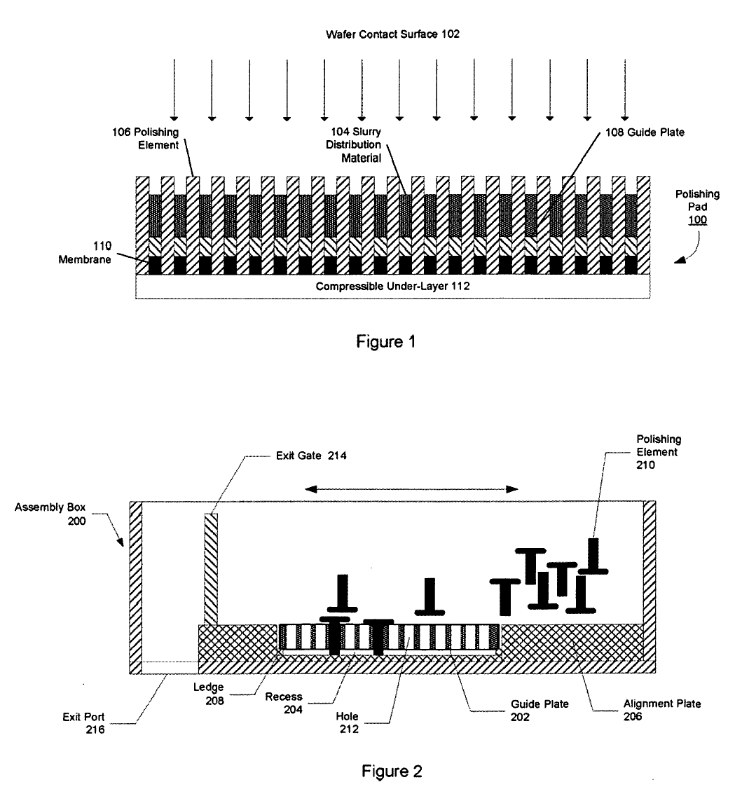

Turning now to FIG. 2, an example of an assembly box 200 is shown in cross section. The illustration is not to scale but is provided to acquaint the reader with the elements of a single assembly box before discussing how the boxes are stacked with one another and operated so as to provide for the assembly of polishing pads. Within assembly box 200, a guide plate 202 is placed in a recess 204 in alignment plate 206. At the bottom of the recess 204 is a circumferential ledge 208 that is adapted to support guide plate 202 around its outermost edge so that a space is left between the bottom of the guide plate and the floor of the recess. This provides room for the polishing elements 210 to protrude through the guide plate 202 when the polishing elements are captured within the holes 212 of the guide plate.

When the automated assembly device is operating, multiple polishing elements 210 are placed in the assembly box 200 and the assembly box is oscillated in a linear, orbital or other fashion so as to distribute the polishing elements over the surface of the guide plate 202 as it lies in recess 204 of the alignment plate 206. As the polishing elements align in a vertical (or nearly vertical) tip down orientation with the holes 212 in the guide plate, they are captured and fall through the holes so as to come to rest within the guide plate with their base portion abutting what will be the bottom of the guide plate. Because the polishing elements protrude through the guide plate they are prevented from coming loose as the assembly box continues to oscillate. The illustration shows two polishing elements that have been so captured and now protrude through respective holes in the guide plate.

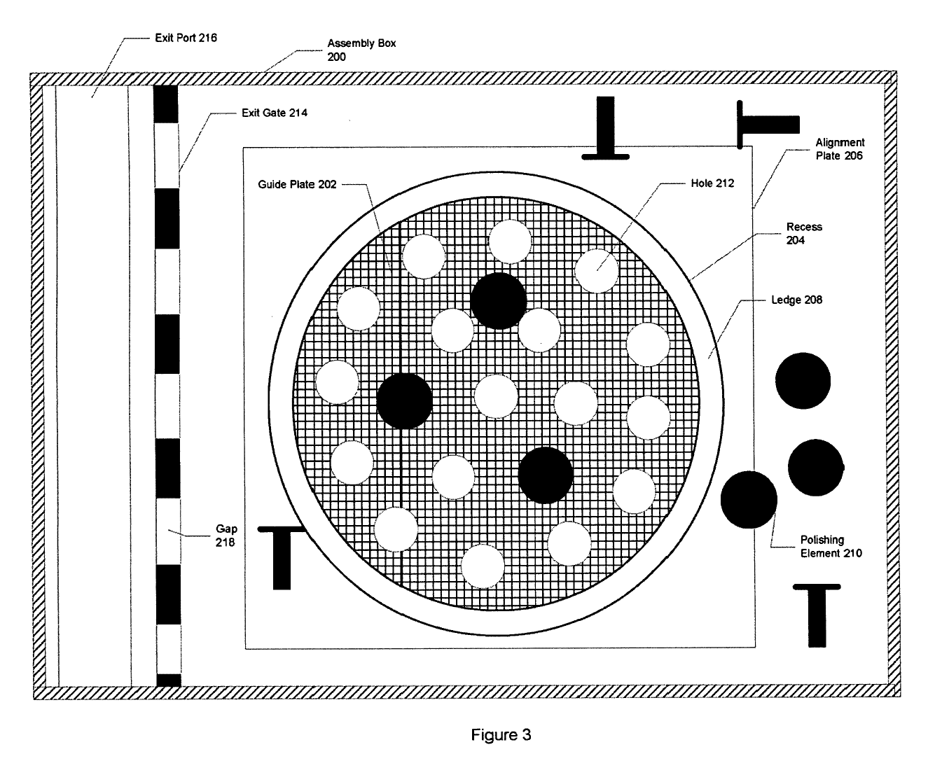

After a time, the assembly box (i.e., the stack of such assembly boxes) is tilted so that all of the polishing elements that have not been captured within a hole of the guide plate will be displaced towards the exit gate 214. The exit gate 214 may be fashioned as a picket fence-like structure (i.e., with slats separated from one another by gaps 218 (see FIG. 3, which is a top view of the assembly box arrangement)) so that it acts to keep some polishing elements 210 contained within the assembly box 200 while the box is oscillated in order to distribute the polishing elements over the guide plate. When the assembly box is tilted, however, the majority of the free polishing elements in the box will pass through the openings in the exit gate and fall out of the assembly box via the exit port 216. The exit gate promotes a more uniform distribution of polishing elements for delivery to the assembly box below.

As will be discussed below, the exit port may be positioned above another assembly box so that the polishing elements fall into the lower box, therein to be dispersed over another guide plate contained in an alignment plate in the lower assembly box. If the exit port of the lower assembly box is displaced on a side opposite that of the exit port of the upper assembly box, then the polishing elements will be contained in the lower assembly box, at least for a time. Thereafter, the assembly box stack can be tilted so that the polishing elements will fall towards the exit port of the lower assembly box and fall into yet a third assembly box positioned thereunder or into a collection area. This cascading of the polishing elements down a stack of assembly boxes permits the rapid assembly of multiple guide plate-polishing element combinations. The cascading also promotes reorientation of elements that have moved across the plate in the flange down position. With some polishing element designs, the aspect ratio of the element results in about half of the polishing elements being flange down and the other half of the polishing elements being flange up. Thus, the first pass will result in only about 50% capture efficiency.

Before discussing the stacked arrangement of assembly boxes in further detail, we refer briefly to FIG. 3 which, as indicated, shows a top view of the assembly box 200. The guide plate 202 is resting on the ledge 208 within recess 204 of alignment plate 206. In this view, the recess 204 is shown exaggerated in order to illustrate the ledge, however, in practice the recess may be kept as small as possible in order to securely hold the guide plate 202. Polishing elements 210 are within the assembly box and, as shown, some have already been captured within holes 212 in the guide plate. The exit gate 214 has a series of gaps 218 through which the polishing elements can pass to fall through exit port 216. in some cases, the exit gate 214 may not be present, however, this may result in a large number of polishing elements falling through the exit port 216 before any significant number thereof are captured in the holes 212, thereby decreasing the throughput of the assembly process.

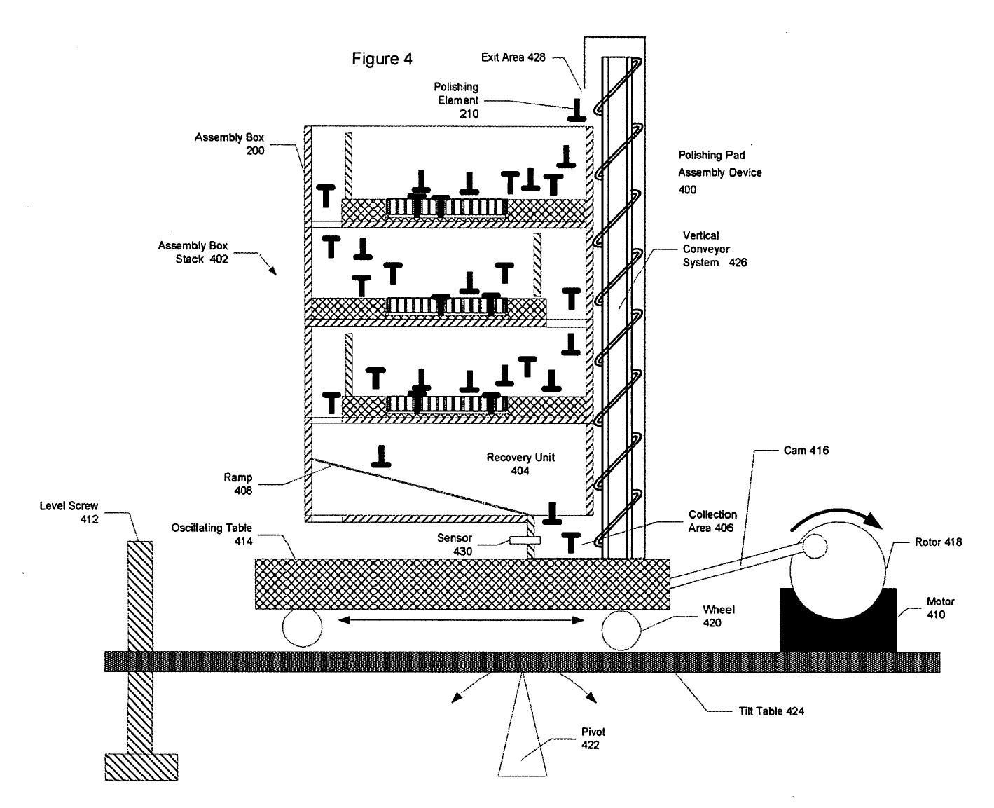

Now turning to FIG. 4, a schematic, cross-sectional view of an automatic polishing pad assembly device 400 that is configured in accordance with an embodiment of the present invention is illustrated. Individual assembly boxes 200 are arranged in a stack 400 such that exit ports of successively lower assembly boxes in the stack are positioned at opposite sides from one another. That is, an exit port of a higher assembly box within the stack is positioned above the next lower assembly box in the stack so that polishing elements passing through the exit port of the higher assembly box fall into the lower assembly box, therein to be dispersed over a guide plate contained in an alignment plate in the lower assembly box. The exit port of that lower assembly box is displaced towards a side opposite that of the exit port of the upper assembly box so that the polishing elements will be contained in the lower assembly box, at least for a time.

At the bottom of the stack 402 is a recovery unit 404. The recovery unit 404 acts to collect polishing elements that have cascaded through all of the assembly boxes in the stack but which have not been captured by any guide plates therein. These polishing elements pass out of the exit port of the lowest most assembly box in the stack and are deposited in a collection area 406 of the recovery unit 404. For example, the polishing elements may tumble down a ramp 408 within the recovery unit 404 and gather within the collection area 406.

The polishing elements are made to cascade down the stack (from exit port to exit port of successively lower assembly boxes in the stack) by a combination of an oscillating motion induced by motor 410 and a tilting action induced by level screw 412. Notice that the stack 402 and recovery unit 404 are assembled on top of an oscillating table 414. A cam 416 connects the oscillating table 414 to the rotor 418 of motor 412, so that as the rotor turns, the rotary motion is converted to linear motion by the cam, which drives the oscillating table 414 fore and aft (i.e., in the longitudinal direction of the assembly boxes in the stack) on its wheels 420. The oscillating motion of the table 414 causes polishing elements in each of the assembly boxes 200 to jostle about, and some of those polishing elements will be captured in the holes of the guide plates as a result.

After a time, the oscillation is temporarily paused and the entire stack is tilted about a pivot 422 through the action of level screw 412. Notice that the oscillating table 412 is positioned on a tilt table 424. The level screw, which passes through tilt table 424 (or is otherwise secured thereto, for example by a bracket) may be driven by an actuator (not shown), first in one direction and then the other, so as to induce tilting of the tilt table in both a forward (positive) and backwards (negative) direction. The tilting of the tilt table (and, hence the entire assembly box stack) in this fashion causes polishing elements to fall through the gates in various ones of the assembly boxes 200 and pass through the respective exit ports therein to the next lower assembly boxes or into the recovery unit. Thus, by combining oscillations (to disperse polishing elements within an assembly box) with tilting operations (oscillate—tilt in positive direction—oscillate—tilt in negative direction, etc), polishing elements can be made to cascade through the stack and either be captured by guide plates within the assembly boxes or collected in the recovery unit.

As polishing elements are collected within the collection are of the recovery unit, they are returned to the top most assembly box by the action of a vertical conveyor system 426. In one embodiment, this vertical conveyor system may comprise a worm screw configured to drive the individual polishing elements from the collection area of the recovery unit to the top most assembly box. An exit area 428 at the top of the vertical assembly unit is positioned so that the polishing elements can exit the vertical conveyor system and fall into the top most assembly box in the stack. The dimensions of the vertical assembly unit and the worm screw may be sized so as to ensure that polishing elements pass freely in the vertical direction without getting stuck and without tumbling to the bottom of the vertical conveyor system.

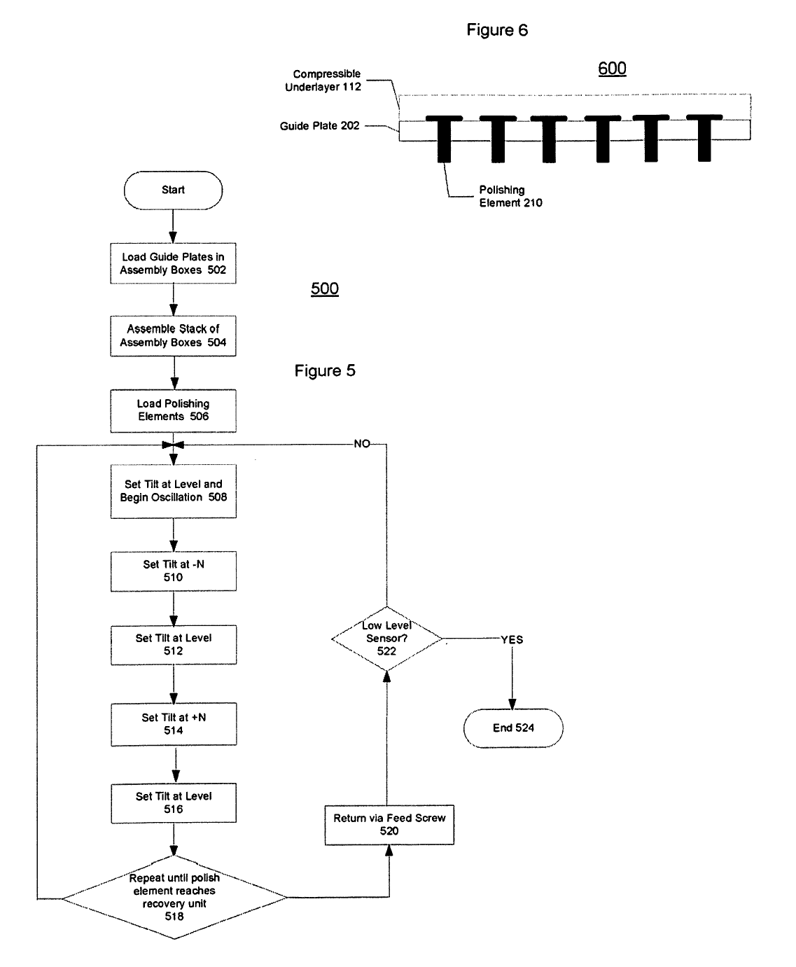

FIG. 5 presents a flow diagram which illustrates one example of an automated assembly process 500 for a polishing pad using the present assembly device. When the process begins, guide plates are loaded into the respective assembly boxes (502) and three assembly boxes are organized into a stack on top of a recovery unit (504). Thereafter, polishing elements are loaded in the top most assembly box in the stack (506) and the oscillation of the stack is commenced (e.g., by engaging the motor to drive the oscillating table in a linear fashion) (508). At this time, the tilt table should be set to level.

After a time (which may be a predetermined time according to the kind of polishing pad to be assembled) the tilt table is tilted (via the level screw) in a first direction (say a negative direction) by an amount N degrees (510), where N may be determined experimentally so as to ensure that most of the uncaptured polishing elements are passed from the top most assembly box in the stack to the next lower assembly box therein via the exit port in the top most assembly box. The tilt table is then returned to level (512) and the oscillation continued so as to displace polishing elements within that next lower assembly box so that some will be captured by the guide plate therein.

Now, after a time (which may be a predetermined time according to the kind of polishing pad to be assembled) the tilt table is tilted (via the level screw) in a second direction (say a positive direction) by an amount M degrees (514), where M may be determined experimentally so as to ensure that most of the uncaptured polishing elements are passed from the current assembly box in which they are located to the next lower assembly box therein via the exit port in the current assembly box. The tilt table is then returned to level (516) and the oscillation continued so as to displace polishing elements within that next lower assembly box so that some will be captured by the guide plate therein. The oscillation amplitude and frequency may also be adjusted based on polishing element type for optimum capture efficiency.

The oscillate-tilt-oscillate-tilt process continues until polishing elements leave the lowest most assembly box in the stack and are collected in the recovery unit (520). From there, the polishing elements are returned to the upper most assembly box by the vertical conveyor unit (522). This entire process continues until a sensor 430 (see FIG. 4) in the collection area of the recovery unit signals that the remaining number of free polishing elements has reached a low level (524) (e.g., a user-defined level for determining when to end the assembly process), at which time the assembly process quits (524). The process may be performed under the control of a computer system (not shown) configured (i.e., programmed) to cause the motor and other actuators to perform so as to achieve the above described operations.

FIG. 6 shows an example of a completed guide plate unit 600 with polishing elements 210 disposed in the holes of a guide plate 210. The polishing elements may be secured by affixing a compressible foam layer (shown in dotted outline) to the back side of the polishing elements and the guide plate. This may be done while the guide plates are in the assembly box or after they are removed therefrom.

Thus, methods and systems for the automated assembly of a polishing pad having individual polishing elements has been described. In the above description, a number of specifically illustrated embodiments were discussed in order to better explain the present invention, however, these examples should not be read to limit the scope of the invention. Instead, the invention should be measured only in terms of the following claims.

What is claimed is:

1. An apparatus for assembling a polishing pad, comprising: one or more assembly boxes, each configured to support a guide plate therein, the guide plate having through holes for accepting polishing elements, and further having an exit port sufficient to permit polishing elements to pass therethrough; means for oscillating the assembly boxes arranged as a stack; and means for tilting the assembly boxes arranged as a stack.

2. The apparatus of claim 1 further comprising a recovery unit adapted to be positioned below the assembly boxes when arranged as a stack and to collect polishing elements into a collection area when said polishing elements pass through a respective exit port of a lowermost one of the assembly boxes arranged as a stack.

3. The apparatus of claim 2 further comprising a vertical conveyor assembly adapted to collect polishing elements from the collection area and to transport said polishing elements to a topmost one of the assembly boxes arranged as a stack.

4. The apparatus of claim 3, wherein the means for oscillating comprises a motor coupled to a table on which the assembly boxes arranged as a stack are positioned.

5. The apparatus of claim 4, wherein the means for titling comprises a tilt table on which rests the table and which is configured to be tilted about a pivot by means of a level screw.

6. An apparatus for assembling a polishing pad, comprising: one or more assembly boxes, each configured to support a guide plate therein, the guide plate having through holes for accepting polishing elements, and further having an exit port sufficient to permit polishing elements to pass therethrough, and means for displacing the assembly boxes arranged as a stack so that the polishing elements are distributed over respective guide plates in respective ones of the assembly boxes and to cascade from an uppermost one of the assembly boxes to a lower most one of the assembly boxes in the stack by means of the exit port in each respective one of the assembly boxes.

7. The apparatus of claim 6 further comprising a collection area for the polishing elements positioned so as to collect the polishing elements when the polishing elements exit the lowermost one of the assembly boxes in the stack.

8. The apparatus of claim 7, wherein the collection area comprises an area of a recovery unit configured to displace the polishing elements from a location where the polishing elements exit the lowermost one of the assembly boxes in the stack to the collection area.

9. The apparatus of claim 8, further comprising a sensor adapted to indicate a level of polishing elements within the collection area.

10. The apparatus of claim 9, further comprising means for delivering the polishing elements from the collection area to the uppermost one of the assembly boxes in the stack.

11. A method, comprising cascading a number of polishing elements through a stack of assembly boxes in each of which are located guide plates having holes there through such that the polishing elements pass from an uppermost assembly box in the stack to a lowermost assembly box in the stack and in each respective assembly box of the stack are distributed over a respective guide plate therein, whereby at least some of the polishing elements are captured within holes of the respective guide plates in the respective assembly boxes.

12. The method of claim 11, wherein the cascading is initiated by displacement of the stack of assembly boxes about a pivot.

13. The method of claim 12, wherein the distribution of the polishing elements within the assembly boxes is initiated by lateral displacement of the assembly boxes in the stack.

14. The method of claim 13, wherein the assembly boxes are oscillated using a motor coupled to a table on which the stack of assembly boxes is located.

15. The method of claim 14, wherein the displacement of the table on which the stack of assembly boxes is located is disposed on a tile table balanced on the pivot.
